(19) United States
(12) Patent Application Publication
(10) Pub. No.: US 2022/0280822 A1
(43) Pub. Date: Sep. 8, 2022

(54) TARGET PIPELINE DYNAMIC THERMAL FAILURE ANALYSIS METHOD IN PARALLEL PIPELINE JET FIRE SCENARIO

(71) Applicant: SOUTH CHINA UNIVERSITY OF TECHNOLOGY, Guangzhou (CN)

(72) Inventors: Guohua CHEN, Guangzhou (CN); Zhihang ZHOU, Guangzhou (CN)

(73) Assignee: SOUTH CHINA UNIVERSITY OF TECHNOLOGY, Guangzhou (CN)

(21) Appl. No.: 17/749,168

(22) Filed: May 20, 2022

Related U.S. Application Data
(63) Continuation of application No. PCT/CN2020/142588, filed on Dec. 31, 2020.

(51) Int. Cl. A62C 35/68; G06F 30/23

(52) U.S. Cl. CPC A62C 35/68; G06F 30/23; G06F 2119/08

(57) ABSTRACT

Disclosed by the present invention is a target pipeline dynamic thermal failure analysis method in a parallel pipeline jet fire scenario, including the following steps: 1, inputting operation parameters of source pipeline to obtain instantaneous thermal radiation value received by target pipeline in instantaneous jet fire near field; 2, establishing fitting function relational expression of the instantaneous thermal radiation value and time change; 3, calculating instantaneous temperature distribution result of the pipe wall of the target pipeline; 4, calculating convective heat transfer coefficient of inner wall of the target pipeline; 5, calculating instantaneous thermal stress and total instantaneous stress borne by the pipe wall of the target pipeline in a circumferential direction, radial direction and axial direction; 6, carrying out testing to obtain yield strength and ultimate tensile strength corresponding to different temperatures; and 7, analyzing and judging target pipeline dynamic failure result.

### CROSS-REFERENCE TO RELATED APPLICATION

This application is a continuation of international application of PCT application serial no. PCT/CN2020/142588 filed on Dec. 31, 2020, which claims the priority benefit of China application no. 201911208936.2 filed on Nov. 30, 2019. The entirety of each of the above mentioned patent applications is hereby incorporated by reference herein and made a part of this specification.

### TECHNICAL FIELD

The present invention relates to the technical field of thermal failure prediction and analysis for natural gas transmission pipelines, and in particular relates to a target pipeline dynamic thermal failure analysis method in a parallel pipeline jet fire scenario.

### RELATED ART

In order to meet increasing demand for energy and take actual engineering problems in aspects of limited space conditions of pipeline laying territories, economic cost for construction and maintenance and the like, the situation of laying natural gas transmission pipelines in parallel in a close spacing is increasing. When the leakage occurs in a source pipeline in the parallel pipeline scenario, a large amount of natural gas stored in the pipe makes jet fires generally last for several hours, moreover, it is basically impossible to implement corresponding fire-fighting measures within those hours. Therefore, accurately pre-judging and analyzing whether the target pipeline fails or not in the parallel pipeline jet fire accident environment and then taking corresponding protection measures in advance are of great importance for preventing the accident domino effect. Most developed countries, such as the United States, the United Kingdom, and Canada, have conducted studies related to failure determination of the target pipeline in the parallel natural gas pipeline jet fire accident scenarios. The main relevant studies in China and at abroad include:

(1) A Target Pipeline Failure Judgment Method Based on Static Thermal Response Analysis

In the existing documents Mazzola A. Thermal interaction analysis in pipeline systems—A case study[J]. Journal of Loss Prevention in the Process Industries, 1999, 12(6): 495-505., Silva E P, Nele M, Frutuoso P F, et al. A numerical approach for evaluation of underground parallel pipelines domino effect—Computational aspects and validation[C]. Rio: Rio Pipeline Conference and Exposition, 2017: 21-30., Ge T M, Hong L, Yao Z. Fire Consequence Analysis for Two Parallel-running Pipelines[C]., ANSYS finite element software, FLUENT software and KFX software are respectively adopted to carry out static thermal response analysis on the target pipeline thermal failure in a jet fire environment; however, none of these methods can calculate failure time; moreover, in these methods, a thermal radiation value received by the target pipeline is set to be a constant value without considering the change process that the thermal radiation value drops along with time in the actual situation.

(2) Simplified Failure Judgment of Target Pipeline Based on Geometric Proportion Method

According to a relative position between a source pipeline and a target pipeline, in the existing document Giovanni Ramirez-Camacho J, Pastor E, Casal J, et al. Analysis of domino effect in pipelines[J]. Journal of Hazardous Materials, 2015, 298: 210-220, it is considered that thermal failure of the target pipeline occurs when the flame of the jet fire is in contact with an outer wall of the target pipeline or when the target pipeline is exposed to a crater created by the bursting of the source pipeline; however, this method is an ideal simplified judgment method that ignores the analysis of the thermal failure process of the target pipeline in the jet fire environment in actual scenarios.

The document studies showed that the static thermal response analysis and the geometric proportion method adopted in the current studies cannot accurately and objectively reflect the dynamic thermal failure process and the corresponding failure result of the target pipeline in the jet fire environment in the actual situation. To this end, in consideration of the unsteady-state characteristic of jet fires in an actual accident scenario and on the basis of calculating an instantaneous thermal radiation value received by the target pipeline, a target pipeline dynamic thermal failure analysis method in an unsteady-state jet fire environment conforming to the actual situation is established based on a MATLAB software platform by using a finite difference method. Therefore, the thermal failure dynamic process of the target pipeline can be accurately pre-judged to provide a method reference for prevention and control of such accidents.

In conclusion, the target pipeline thermal failure analysis in the current studies only employs a static thermal response analysis method, the heat flux received by the outer wall of the target pipeline is assumed to be a fixed value. However, these methods and assumptions do not conform to the actual accident scenario situation. For this problem, a target pipeline dynamic thermal failure analysis method in consideration of an instantaneous characteristic of jet fires in an actual scenario is provided by the present invention, which makes an analysis result more conform to the actual situation and can prevent the target pipeline from thermal failure in the aspect of optimizing the safety distance.

### SUMMARY OF INVENTION

In accordance with a target pipeline dynamic thermal failure analysis method in a parallel pipeline jet fire scenario, in a parallel natural gas transmission pipeline jet fire accident scenario, a source pipeline refers to a natural gas pipeline in which damage leakage occurs to generate jet fires at first, and a target pipeline is an adjacent pipeline which subsequently undergoes thermal failure in the jet fire environment. Wherein the method comprises inputting an instantaneous thermal radiation value received by the target pipeline as a heat source parameter of a thermal response finite difference model, thus obtaining a target pipeline dynamic thermal failure process conforming to an actual situation.

For the problem that there are conditions which are excessively simplified in assumption and do not conform to the actual situation in an existing target pipeline thermal failure judgment and analysis technology, the instantaneous thermal radiation value received by the target pipeline in the non-steady state jet fire environment that conforms to the actual situation is obtained, and a target pipeline dynamic thermal failure analysis method capable of improving the accuracy of pre-judgment is established.

The present invention is achieved at least by one of the following technical solutions.

A target pipeline dynamic thermal failure analysis method in a parallel pipeline jet fire scenario, comprising the following steps:

(1), inputting operation parameters of a source pipeline to obtain an instantaneous thermal radiation value received by a target pipeline in an instantaneous jet fire near field;

(2), establishing a fitting function relational expression of the instantaneous thermal radiation value and time change;

(3), obtaining a convective heat transfer coefficient of an inner wall of the target pipeline;

(4), obtaining an instantaneous temperature distribution result of a pipe wall of the target pipeline;

(5), obtaining instantaneous thermal stress and total instantaneous stress borne by the pipe wall of the target pipeline in a circumferential direction, a radial direction and an axial direction;

(6), carrying out testing to obtain yield strength and ultimate tensile strength corresponding to different temperatures; and

(7), analyzing and judging a target pipeline dynamic failure result, and optimizing a safety spacing of the parallel pipelines for a condition of thermal failure of the target pipeline, thus preventing the target pipeline from thermal failure.

Further, the step (1) is specifically as follows:

obtaining the instantaneous thermal radiation value qₜ received by the target pipeline in the instantaneous jet fire near field by using a weighted multi-point source thermal radiation model after heat source weight optimization and improvement, with expressions as follows:

$$\begin{matrix}{q}_{t} = {\sum }_{j = 1}^{N} \frac{{w}_{j} {τ}_{j} {χ}_{r} \dot{m} Δ {H}_{c}}{4 π {S}_{j}^{2}} cos {φ}_{j} & ( 1 ) \\ {χ}_{r} = \frac{0.009 \sqrt{{ρ}_{0} / {ρ}_{∞}}}{{f}_{s}} {Fr}_{f}^{- 0.265} & ( 2 ) \\ {w}_{j} = \frac{1}{2 a} {e}^{- \frac{\vert {z}_{j} / {H}_{f} - b \vert}{c}} & ( 3 ) \\ \{ \begin{matrix}a = 0.175 {Fr}_{f} + 4.098 \\ b = - 0.0383 {Fr}_{f} + 0.67 \\ c = 0.02 {Fr}_{f} + 0.247\end{matrix} & ( 4 )\end{matrix}$$

wherein χᵣ is a thermal radiation fraction, wⱼ refers to the heat source weight of the j-th heat source point, Fr_{f} is a flame Froude number, Sⱼ is a _{di}stance (m) between a heat source point and an outer wall of the target pipeline, ΔH_{c} is heat of combustion (kJ/kg) for natural gas, \dot{m} is a mass flow rate (kg/s) of an instantaneous leakage process, τⱼ is an air transmissivity, H_{f} is a visible flame length (m), N is the total number of flame axial heat source points, Zⱼ is an axial position (m) of the j-th heat source point, φⱼ is an included angle between a connecting line of the j-th heat source point and a target and a normal direction of a target surface, ρ₀ is the density (kg/m³) of natural gas, ρ_{∞} is the density (kg/m³) of ambient air, and a, b and c are constant coefficients.

Further, in the step (2), a Levebberg-Marquardt algorithm is used to perform fitting to obtain a fitting function relational expression of the instantaneous thermal radiation value and time change.

Further, a calculation mode of the step (3) is as follows:

$$\begin{matrix}{h}_{in} = {Nu}_{in} \frac{k}{{D}_{in}} & ( 5 ) \\ {Nu}_{in} = \frac{( {Re}_{in} - 1000 ) Pr ( {f}_{F} / 8 )}{1 + 12.7 {( {f}_{F} / 8 )}^{0.5} [ {Pr}^{2 / 3} - 1 ]} & ( 6 ) \\ {f}_{F} = \frac{1}{{4 [ 1.14 - 2 {log}_{10} ( ɛ / {D}_{in} ) ]}^{2}} , \frac{ɛ}{{D}_{in}} ⪢ \frac{9.35}{{Re}_{in} \sqrt{4 {f}_{F}}} & ( 7 )\end{matrix}$$

wherein hᵢₙ is a convective heat transfer coefficient of the inner wall of the target pipeline, Dᵢₙ is an inner diameter of the target pipeline, Nuᵢₙ is a heat transfer Nusselt number of the inner wall of the pipeline, f_{F} is a Fanning friction factor of the inner wall of the pipeline, k is a heat conductivity of a pipe material, Reᵢₙ is a Reynolds number of the natural gas in the pipe; Pr is a Prandtl number of the natural gas, and ε is the roughness of the inner wall of the pipeline.

Further, in the step (4), by taking the function relational expression obtained in the step (2) as an outer wall heat source input boundary condition and taking the convective heat transfer coefficient of the inner wall of the target pipeline obtained in the step (3) as an inner wall forced-convection heat transfer boundary condition, a dynamic thermal response finite difference model of the target pipeline under the action of instantaneous thermal radiation is established based on a MATLAB software platform, thus obtaining an instantaneous temperature T_{m,n}⁽ⁱ⁾ distribution result of the pipe wall, wherein corresponding expressions of the inner wall boundary condition and the outer wall boundary condition in the finite difference model are as follows:

the expression of the outer wall heat source input boundary condition is as follows:

$$k Δ y \frac{{T}_{m - 1 , n}^{( i )} - {T}_{m , n}^{( i )}}{Δ x} + k \frac{{T}_{m , n + 1}^{( i )} - {T}_{m , n}^{( i )}}{Δ y} \frac{Δ x}{2} + k \frac{Δ x}{2} \frac{{T}_{m , n + 1}^{( i )} - {T}_{m , n}^{( i )}}{Δ y} + {q}_{t}^{( i )} Δ y = ρ C \frac{{T}_{m , n}^{( i + 1 )} - {T}_{m , n}^{( i )}}{Δ t} \frac{Δ x}{2} Δ y \qquad ( 8 )$$

an obtaining expression of the inner wall forced-convection heat transfer boundary condition is as follows:

$$k Δ y \frac{{T}_{m - 1 , n}^{( i )} - {T}_{m , n}^{( i )}}{Δ x} + k \frac{{T}_{m , n + 1}^{( i )} - {T}_{m , n}^{( i )}}{Δ y} \frac{Δ x}{2} + k \frac{Δ x}{2} \frac{{T}_{m , n + 1}^{( i )} - {T}_{m , n}^{( i )}}{Δ y} + {h}_{in} ( {T}_{in} - {T}_{m , n}^{( i )} ) Δ y = ρ C \frac{{T}_{m , n}^{( i + 1 )} - {T}_{m , n}^{( i )}}{Δ t} \frac{Δ x}{2} Δ y \qquad ( 9 )$$

wherein k is the heat conductivity (W/(m·K)) of the pipe material, Δy and Δx are respectively a radial distance step (m) and an axial distance step (m) of the pipe wall, qₜ⁽ⁱ⁾ is the instantaneous thermal flux (kW/m²) received by the outer wall of the pipeline at the moment i, ρ is the density (kg/m³) of the pipe material, C is the specific heat capacity (J/(kg·K)) of the pipe material, Δt is a time step, Tᵢₙ is a temperature of the natural gas in the pipe, n and m are the number of axial nodes and the number of radial nodes, and i is time (s).

Further, in the step (5), the instantaneous thermal stress σ^{T} borne by the pipe wall in a circumferential direction, a radial direction and an axial direction is obtained based on the instantaneous temperature distribution result of the pipe wall obtained in the step (4), and a result of the total instantaneous stress σ born by the pipe wall is obtained by superposing pressure stress generated by the internal pressure of the pipeline, the corresponding expressions are as follows:

$$\begin{matrix}Circumferential thermal stress \text{:} {σ}_{t}^{T} = \frac{{τ}_{p} {E}_{p}}{( 1 - ϕ ) {r}^{2}} [ \frac{{r}^{2} + {R}_{in}^{2}}{{R}_{ot}^{2} - {R}_{in}^{2}} {\int }_{{R}_{in}}^{{R}_{ot}} T ( r ) rdr + {\int }_{{R}_{in}}^{r} T ( r ) rdr - T ( r ) {r}^{2} ] & ( 10 ) \\ Radial thermal stress \text{:} {σ}_{r}^{T} = \frac{{τ}_{p} {E}_{p}}{( 1 - ϕ ) {r}^{2}} [ \frac{{r}^{2} + {R}_{in}^{2}}{{R}_{ot}^{2} - {R}_{in}^{2}} {\int }_{{R}_{in}}^{{R}_{ot}} T ( r ) rdr - {\int }_{{R}_{in}}^{r} T ( r ) rdr ] & ( 11 ) \\ Axial thermal stress \text{:} {σ}_{l}^{T} = \frac{{τ}_{p} {E}_{p}}{1 - ϕ} [ \frac{2}{{R}_{ot}^{2} - {R}_{in}^{2}} {\int }_{{R}_{in}}^{{R}_{ot}} T ( r ) rdr - T ( r ) ] & ( 12 )\end{matrix}$$

Wherein Rₒₜ is an outer radius (m) of the pipe wall, Rᵢₙ is an inner radius (m) of the pipe wall, τₚ is a thermal expansion coefficient of the pipe material, Eₚ is an elastic modulus (Mpa) of the pipe material, ϕ is the Poisson's ratio of the pipe material, r is a radial position (m), and T(r) is a pipe wall temperature (K) at the radial position r.

$$\begin{matrix}Circumferential pressure stress \text{:} {σ}_{t}^{P} = \frac{{P}_{in} {R}_{in}^{2}}{{R}_{ot}^{2} - {R}_{in}^{2}} ( 1 + \frac{{R}_{ot}^{2}}{{r}^{2}} ) & ( 13 ) \\ Rad ial pressure stress \text{:} {σ}_{r}^{P} = \frac{{P}_{in} {R}_{in}^{2}}{{R}_{ot}^{2} - {R}_{in}^{2}} ( 1 - \frac{{R}_{ot}^{2}}{{r}^{2}} ) & ( 14 ) \\ Axial pressure stress \text{:} {σ}_{l}^{P} = \frac{{P}_{in} {R}_{in}^{2}}{{R}_{ot}^{2} - {R}_{in}^{2}} & ( 15 ) \\ Total c ircumferential stress \text{:} {σ}_{t} = {σ}_{t}^{T} + {σ}_{t}^{P} & ( 16 ) \\ Total radial stress \text{:} {σ}_{r} = {σ}_{r}^{T} + {σ}_{r}^{P} & ( 17 ) \\ Total ax ial stress \text{:} {σ}_{l} = {σ}_{l}^{T} + {σ}_{l}^{P} & ( 18 )\end{matrix}$$

wherein Pᵢₙ is an operating pressure (Mpa) of the target pipeline.

Further, in the step (6), a tensile strength data result of the pipe material under different temperatures is obtained by a tensile testing at elevated temperature according to the pipe wall temperature range obtained in the step (4), and the yield strength σₛ and the ultimate tensile strength σ_{b} corresponding to any temperature in the testing temperature range are obtained through a linear difference value.

Further, in the step (7), by adopting a failure judgment criterion based on the maximum tensile stress theory, the elastic failure stress Δσₑ of the target pipeline is defined as a difference value obtained by subtracting the yield strength of the pipe material at the corresponding temperature from the obtained total stress in each direction born by a certain position of the pipe wall, the judgment criterion of the elastic failure of the pipeline is that the maximum elastic failure stress max(Δσₑ) of the pipe wall is greater than or equal to 0 MPa; and meanwhile, the fracture failure stress Δσᵣ of target pipeline is defined as a difference value obtained by subtracting the ultimate tensile strength of the pipe material at corresponding temperature from obtained total stress in each direction born by a certain position of the pipe wall, and the judgment criterion of the elastic failure of the pipeline is that the maximum fracture failure stress max(Δσₑ) of the pipe wall is greater than or equal to 0 MPa; a failure result of the target pipeline is accurately obtained according to the failure judgment criterion, the failure result comprises failure time, failure position, and failure mode; and the failure judgment expression is as follows:

Elastic failure: max(Δσₑ)=max(σₜ−σₛ)≥0 MPa (19)

Fracture failure: max(Δσᵣ)=max(σₜ−σ_{b})≥0 MPa (20)

if the analysis result shows that the target pipeline undergoes the thermal failure, the safety spacing between the parallel pipelines can be further optimized, and above calculation and analysis are repeated until the analysis result is that the target pipeline is safe.

Compared with the prior art, the method provided by the present invention has the following advantages:

(1), an instantaneous heat radiation value received by the outer wall of the target pipeline in the unsteady-state jet fire environment conforming to the actual situation is obtained by using a weighted multi-point source thermal radiation model after heat source weight optimization and improvement. On the one hand, the prediction accuracy of the thermal radiation value received by the outer wall of the target pipeline in the jet fire near field is improved; on the other hand, the defect that the thermal radiation value received by the outer wall of the target pipeline is assumed to be a constant value in the existing analysis technology is overcome; and

(2) compared with an existing static failure analysis technology, a finite difference model for the target pipeline thermal response in the unsteady-state jet fire environment is established to analyze and obtain a target pipeline dynamic thermal failure process conforming to the actual accident scenario, so that the failure time and failure mode are accurately judged, the accuracy of the target pipeline thermal failure analysis result is improved, and the target pipeline is prevented from thermal failure by optimizing the safety spacing of the parallel pipelines.

### BRIEF DESCRIPTION OF DRAWINGS

FIG. 1 is a schematic diagram of a parallel natural gas transmission pipeline jet fire accident scenario in accordance with an embodiment;

FIG. 2 is a schematic diagram of a plane of a typical accident case in accordance with an embodiment;

FIG. 3 illustrates a target pipeline dynamic thermal failure analysis method in a parallel natural gas transmission pipeline jet fire accident scenario in accordance with an embodiment;

FIG. 4 illustrates an instantaneous thermal radiation value result received by an outer wall of a target pipeline in accordance with an embodiment;

FIG. 5 illustrates instantaneous temperature results of an inner wall and an outer wall of a target pipeline in accordance with an embodiment;

FIG. 6 illustrates an instantaneous temperature distribution result of a pipe wall of a target pipeline in accordance with an embodiment;

FIG. 7 illustrates a tensile strength result of a pipe material of a target pipeline in accordance with an embodiment at different temperatures;

FIG. 8a illustrates an instantaneous fracture failure stress distribution result of a pipe wall of a target pipeline in accordance with an embodiment;

FIG. 8b illustrates an instantaneous elastic failure stress distribution result of a pipe wall of a target pipeline in accordance with an embodiment;

FIG. 9a illustrates an instantaneous fracture failure stress distribution result of a pipe wall of a target pipeline in accordance with an embodiment after optimizing a safety spacing of the parallel pipelines;

FIG. 9b illustrates an instantaneous elastic failure stress distribution result of a pipe wall of a target pipeline in accordance with an embodiment after optimizing a safety spacing of the parallel pipelines.

### DESCRIPTION OF EMBODIMENTS

Embodiments of the present invention are further described below with reference to the accompanying drawings, but the embodiments and protection of the present invention are not limited thereto. It needs to be noted that anything not specifically described in detail below can be achieved by those skilled in the art with reference to the prior art.

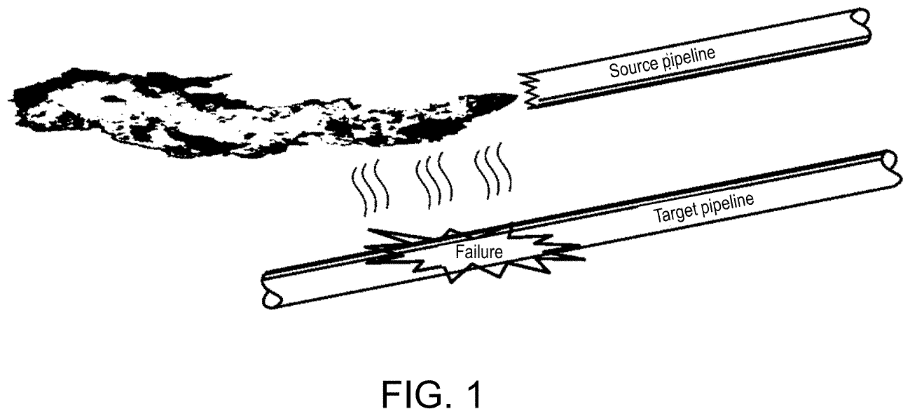

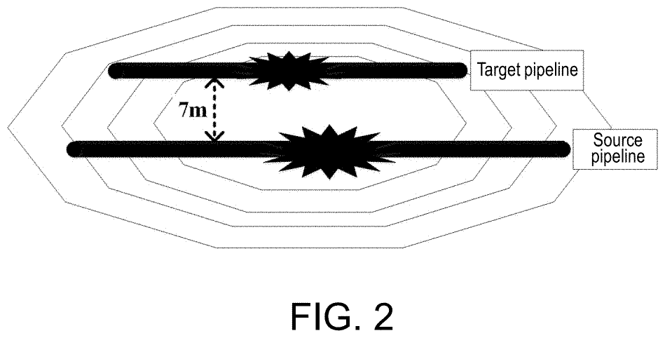

FIG. 2 is a schematic diagram of a plane of an accident case of parallel natural gas transmission pipelines in accordance with an embodiment. In this typical accident case, a high-pressure natural gas pipeline (a source pipeline) having an outer diameter of 1.067 m bursts first, which produces a crater having a length of 51 m, a width of 23 m, and a depth of 5 m, and makes a part of a pipe section of an adjacent natural gas pipeline (a target pipeline) which is laid in parallel and has an outer diameter of 0.914 m be suspended in the crater. Afterwards, the natural gas is simultaneously ejected from the two ends of the fractured source pipeline at high pressure, the ejected natural gas is immediately ignited to form jet fires, and the jet fires generate thermal radiation effect to lead to thermal failure of the target pipeline; the target pipeline is an adjacent natural gas pipeline which subsequently undergoes thermal failure in the jet fire environment. A parallel natural gas transmission pipeline jet fire accident scenario is schematically shown in FIG. 1. Finally, the target pipeline is subjected to complete axial fracture. Based on the detailed information of the accident report, the data of relevant input parameters required in the embodiments of the present invention is collated, which is specifically as shown in Table 1.

TABLE 1
Input parameter required for target pipeline thermal failure analysis

| Parameter | Numerical value and unit | |
|---|---|---|
| Distance from a fracture position of a | 111.18 | km |
| source pipeline to an upstream block valve | | |
| station | | |
| Distance from a fracture position of a | 108.58 | km |
| source pipeline to a downstream block | | |
| valve station | | |
| Operating pressure of the source pipeline | 6.068 | MPa |
| Outer diameter of the source pipeline | 1.067 | m |
| Steel grade of pipe material of the source | API 5L X65 | |
| pipeline | | |
| Operating pressure of the target pipeline | 6.068 | MPa |
| Gas flow rate of the target pipeline | 6.96 | m/s |
| Outer diameter of the target pipeline | 0.914 | m |
| Wall thickness of the target pipeline | 8.74 | mm |
| Steel grade of the pipe material of the | API 5L X60 | |
| target pipeline | | |
| Net spacing between the source pipeline | 7 | m |
| and the target pipeline | | |
| Fracture length of the source pipeline | 10.5 | m |
| Temperature of ambient air | 280K | |
| Pressure of ambient pressure | 101.89 | kPa |
| Temperature of natural gas in the target | 310K | |
| pipeline | | |

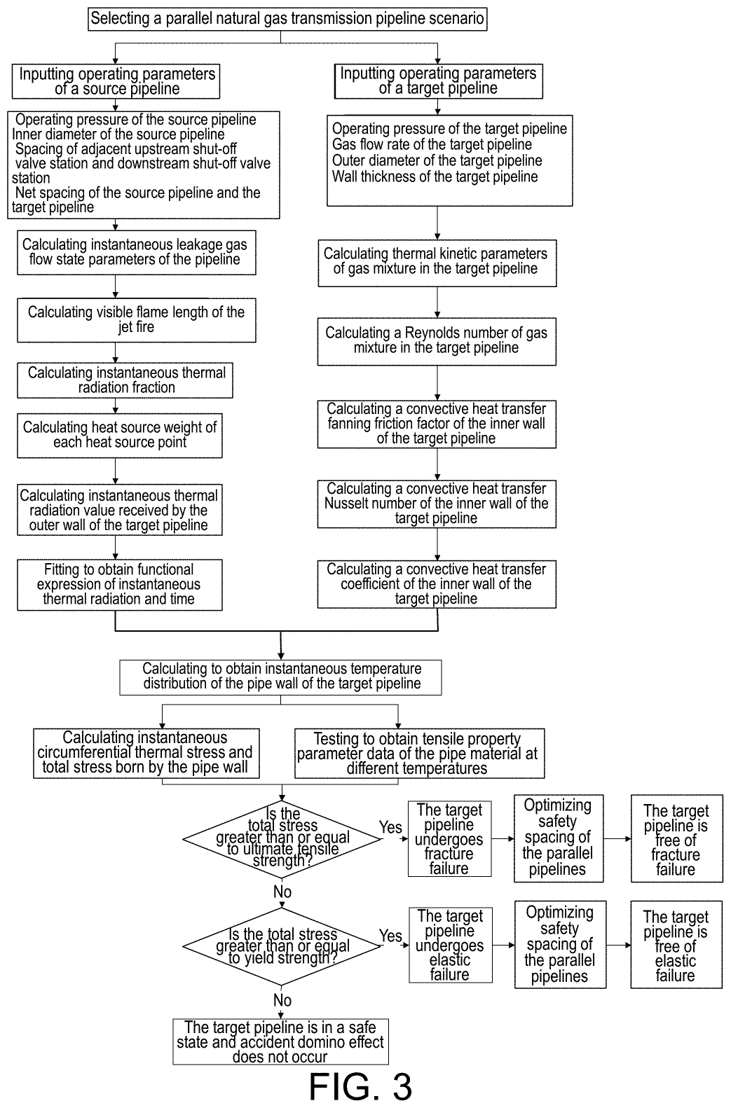

In this embodiment, a target pipeline dynamic thermal failure analysis method in a parallel pipeline jet fire scenario as shown in FIG. 3 includes the following steps:

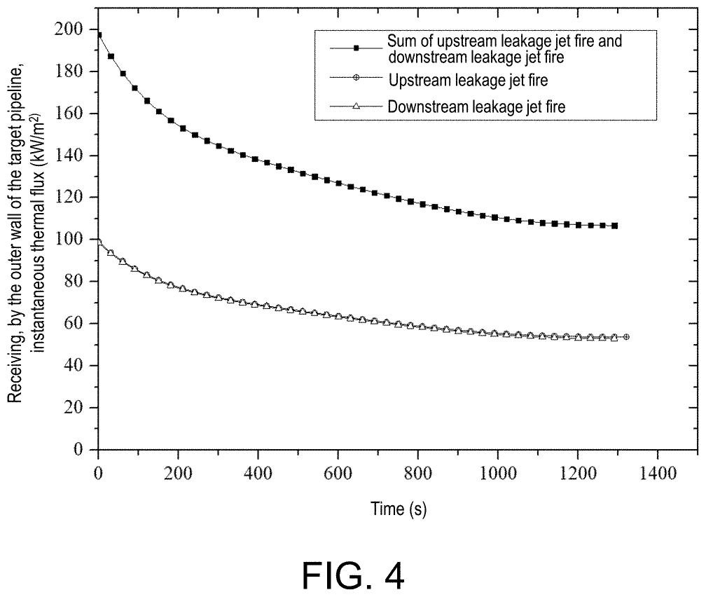

step (1), calculating an instantaneous thermal radiation value received by an outer wall of a target pipeline in a jet fire environment according to operating parameters of a source pipeline in a parallel natural gas transmission pipeline jet fire accident scenario, wherein the thermal radiation value is the sum of the instantaneous thermal radiation values under the action of the upstream pipeline leakage jet fire and the downstream pipeline leakage jet fire; an initial thermal radiation value is 196.352 kW/m², and a calculation result of the specific instantaneous thermal radiation value is as shown in FIG. 4, with the specific process as follows:

at first, the Peng-Robinson two-parameter cubic gas state equation is applied to calculate gas state parameters of the source pipeline in the instantaneous leakage process of high-pressure natural gas, with an expression as follows:

$$P = \frac{RT}{υ - B} - \frac{A}{( υ + {c}_{1} B ) ( υ + {c}_{2} B )} \qquad ( 1 )$$

wherein

$$A = \frac{{k}_{1} {R}^{2} {T}_{c}^{2}}{{P}_{c}^{2}} , B = \frac{{k}_{2} R {T}_{c}}{{P}_{c}} , {c}_{1} = 1 - \sqrt{2} , {c}_{2} = 1 + \sqrt{2} , {k}_{1} = 0.45724 , {k}_{2} = 0 .0778$$

and v are the volume occupied by gas per unit mass (m³/mol), P_{c} is a gas critical pressure (Pa), T_{c} is a gas critical temperature (K), P is a gas pressure in the target pipeline, R is a universal gas constant (J/(mol·K)), T is a gas temperature (K), A and B are intermediate dimensionless parameters, and c₁, c₂, k₁ and k₂ are all constant coefficients.

Secondly, a visible flame length (H_{f}) (subtracting a flame push distance from the total flame length) and a thermal radiation fraction of a corresponding unsteady-state jet fire working condition is obtained according to the gas state parameters in the instantaneous leakage process, with an expression as follows:

$$\begin{matrix}Total flame length ( H ) : & \\ \frac{H}{d} = 63.85 {U}^{* 0.38} & ( 2 )\end{matrix}$$

wherein H is the total flame length (m), U* is a dimensionless parameter containing combustion kinetic parameters of the flame, and d is a diameter (m) of a leakage opening of the source pipeline.

Flame push distance (Hₗ): log(Hₗ/d)=0.19(u/Sᵤ)Re^{-0.36}+0.411 (3)

wherein Hₗ is the flame push distance (m), u is a flow rate (m/s) of an outlet, Sᵤ is a methane maximum laminar combustion rate (m/s), and Re is a Reynolds number of the outlet.

$$\begin{matrix}Visible flame length ( {H}_{f} ) : & \\ {H}_{f} = H - {H}_{1} & ( 4 ) \\ Thermal radiation fraction ( {χ}_{r} ) : & \\ {χ}_{r} = \frac{0.009 \sqrt{{ρ}_{0} / {ρ}_{∞}}}{{f}_{s}} F {r}_{f}^{- 0.265} & ( 5 )\end{matrix}$$

wherein fₛ is a mass percentage of the natural gas at a chemical equivalent ratio of the natural gas to the air, ρ₀ is the density (kg/m³) of the natural gas, and ρ_{∞} is the density (kg/m³) of ambient air.

Finally, the instantaneous thermal radiation value received by an outer wall of the target pipeline is obtained by using a weighted multi-point source thermal radiation model after heat source weight parameter optimization, with expressions as follows:

$$\begin{matrix}{q}_{t} = {\sum }_{j = 1}^{N} \frac{{w}_{j} {τ}_{j} {χ}_{r} \dot{m} Δ {H}_{c}}{4 {S}_{j}^{2}} {cosφ}_{j} & ( 6 ) \\ {w}_{j} = \frac{1}{2 a} {e}^{- \frac{\vert {Z}_{j} / {H}_{f} - b \vert}{c}} & ( 7 ) \\ \{ \begin{matrix}a = 0.175 F {r}_{f} + 4.098 \\ b = - 0.0383 F {r}_{f} + 0.67 \\ c = 0.02 F {r}_{f} + 0.247\end{matrix} & ( 8 )\end{matrix}$$

wherein χᵣ is a thermal radiation fraction, wⱼ refers to the heat source weight of the j-th heat source point, Fr_{f} is a flame Froude number, Sⱼ is a distance (m) between a heat source point and an outer wall of the target pipeline, ΔH_{c} is heat of combustion (kJ/kg) for natural gas, \dot{m} is a mass flow rate (kg/s) of an instantaneous leakage process, τⱼ is an air transmissivity, H_{f} is a visible flame length (m), N is the total number of flame axial heat source points, Zⱼ is an axial position (m) of the j-th heat source point, φⱼ is an included angle between a connecting line of the j-th heat source point and a target and a normal direction of a target surface, ρ₀ is the density (kg/m³) of natural gas, ρ_{∞} is the density (kg/m³) of ambient air, and a, b and c are constant coefficients.

In the step (2), a Levebberg-Marquardt algorithm is used to perform fitting to obtain a quintic polynomial function relational expression of the instantaneous thermal radiation value and time change, the expression being as follows:

qₜ=196.352−0.327t+7.638×10⁻⁴t²−1.028×10⁻⁶t³+6.660×10⁻¹⁰t⁴−1.613×10⁻¹³t⁵ (9)

Step (3), inputting operating parameters of the target pipeline to obtain a convective heat transfer coefficient of an inner wall of the target pipeline as 282.27 W/(m²K), wherein the convective heat transfer coefficient of the inner wall of the target pipeline is obtained by applying the following expressions:

$$\begin{matrix}{h}_{in} = N {u}_{in} \frac{k}{{D}_{in}} & ( 10 ) \\ N {u}_{in} = \frac{( R {e}_{in} - 1000 ) P r ( {f}_{F} / 8 )}{1 + 12.7 {( {f}_{F} / 8 )}^{0.5} [ P {r}^{2 / 3} - 1 ]} & ( 11 ) \\ {f}_{F} = \frac{1}{{4 [ 1.14 - 2 {log}_{10} ( ɛ / {D}_{in} ) ]}^{2}} , \frac{E}{{D}_{in}} ⪢ \frac{9.35}{R {e}_{i n} \sqrt{4 {f}_{F}}} & ( 12 )\end{matrix}$$

wherein hᵢₙ is a convective heat transfer coefficient of the inner wall of the target pipeline, Dᵢₙ is an inner diameter of the target pipeline, Nuᵢₙ is a heat transfer Nusselt number of the inner wall of the pipeline, f_{F} is a Fanning friction factor of the inner wall of the pipeline, k is a heat conductivity of a pipe material, Reᵢₙ is a Reynolds number of the natural gas in the pipe; Pr is a Prandtl number of the natural gas, and ε is the roughness of the inner wall of the pipeline.

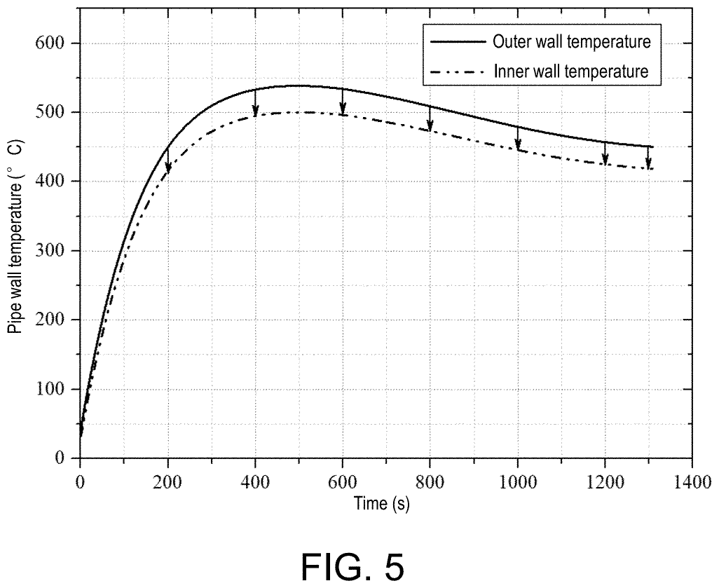

Step (4), the step (4) referring to establish a dynamic thermal response finite difference model of the target pipeline under the action of instantaneous thermal radiation based on a MATLAB software platform by taking the function relational expression obtained in the step (2) as an outer wall heat source input boundary condition and taking the convective heat transfer coefficient of the inner wall of the target pipeline obtained in the step (3) as an inner wall forced-convection heat transfer boundary condition, thus obtaining an instantaneous temperature T_{m,n}⁽ⁱ⁾ distribution result of the pipe wall. As shown in FIG. 5, the outer wall temperature reaches a maximum of 538.4° C. at the 497-th second, while the inner wall temperature is 500.1° C. at the moment, and then the outer wall temperature starts to gradually drop again. The inner wall temperature reaches a maximum of 500.2° C. at the 508-th second, and the outer wall temperature starts to drop gradually again; and corresponding expressions of the inner wall boundary condition and the outer wall boundary condition in the finite difference model are as follows:

the expression of the outer wall heat source input boundary condition is as follows:

$$k Δ y \frac{{T}_{m - 1 , n}^{( i )} - {T}_{m , n}^{( i )}}{Δ x} + k \frac{{T}_{m , n + 1}^{( i )} - {T}_{m , n}^{( i )}}{Δ y} \frac{Δ x}{2} + k \frac{Δ x}{2} \frac{{T}_{m , n - 1}^{( i )} - {T}_{m , n}^{( i )}}{Δ y} + {q}_{t}^{( i )} Δ y = ρ C \frac{{T}_{m , n}^{( i + 1 )} - {T}_{m , n}^{( i )}}{Δ t} \frac{Δ x}{2} Δ y \qquad ( 13 )$$

the expression for obtaining the inner wall forced-convection heat transfer boundary condition is as follows:

$$k Δ y \frac{{T}_{m - 1 , n}^{( i )} - {T}_{m , n}^{( i )}}{Δ x} + k \frac{{T}_{m , n + 1}^{( i )} - {T}_{m , n}^{( i )}}{Δ y} \frac{Δ x}{2} + k \frac{Δ x}{2} \frac{{T}_{m , n - 1}^{( i )} - {T}_{m , n}^{( i )}}{Δ y} + {h}_{m} ( {T}_{in} - {T}_{m , n}^{( i )} ) Δ y = ρ C \frac{{T}_{m , n}^{( i + 1 )} - {T}_{m , n}^{( i )}}{Δ t} \frac{Δ x}{2} Δ y \qquad ( 14 )$$

wherein k is the heat conductivity (W/(m·K)) of the pipe material, Δy and Δx are respectively a radial distance step (m) and an axial distance step (m) of the pipe wall, qₜ⁽ⁱ⁾ is the instantaneous thermal flux (kW/m²) received by the outer wall of the pipeline at the moment i, ρ is the density (kg/m³) of the pipe material, C is the specific heat capacity (J/(kg·K)) of the pipe material, Δt is a time step, Tᵢₙ is a temperature of the natural gas in the pipe, n and m are the number of axial nodes and the number of radial nodes, and i is time (s).

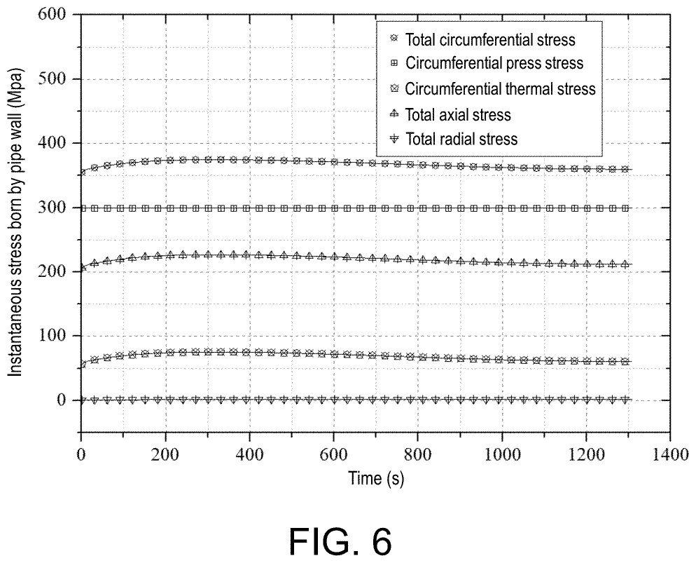

Step (5), obtaining results of instantaneous thermal stress and total instantaneous stress borne by the pipe wall of the target pipeline in a circumferential direction, a radial direction and an axial direction, as shown in FIG. 6; obtaining the instantaneous thermal stress σ^{T} borne by the pipe wall in the circumferential direction, the radial direction and the axial direction based on the instantaneous temperature distribution result of the pipe wall obtained in the step (4), and obtaining the result of the total instantaneous stress σ born by the pipe wall by superposing pressure stress generated by the internal pressure of the pipeline. In terms of the three-dimensional stress born by the pipe wall, the total circumferential stress is obviously the largest, followed by the total axial stress, and the smallest is the total radial stress. The maximum circumferential thermal stress is 75.4 MPa, corresponding to a maximum total circumferential stress of 374.6 MPa, with the corresponding expressions as follows:

$$\begin{matrix}Circumferential thermal stre \text{ss:} & \\ {σ}_{t}^{T} = \frac{{τ}_{p} {E}_{p}}{( 1 - ϕ ) {r}^{2}} [ \frac{{r}^{2} + {R}_{i n}^{2}}{{R}_{ot}^{2} - {R}_{i n}^{2}} {\int }_{{R}_{in}}^{{R}_{ot}} T ( r ) r d r + {\int }_{{R}_{in}}^{r} T ( r ) r d r - T ( r ) {r}^{2} ] & ( 15 ) \\ Radial thermal stres \text{s:} & \\ {σ}_{r}^{T} = \frac{{τ}_{p} {E}_{p}}{( 1 - ϕ ) {r}^{2}} [ \frac{{r}^{2} - {R}_{i n}^{2}}{{R}_{ot}^{2} - {R}_{i n}^{2}} {\int }_{{R}_{in}}^{{R}_{ot}} T ( r ) r d r - {\int }_{{R}_{in}}^{r} T ( r ) r d r ] & ( 16 ) \\ Axial thermal stres \text{s:} & \\ {σ}_{1}^{T} = \frac{{τ}_{p} {E}_{p}}{1 - ϕ} [ \frac{2}{{R}_{ot}^{2} - {R}_{in}^{2}} {\int }_{{R}_{in}}^{{R}_{ot}} T ( r ) r d r - T ( r ) ] & ( 17 )\end{matrix}$$

Wherein Rₒₜ is an outer radius (m) of the pipe wall, Rᵢₙ is an inner radius (m) of the pipe wall, τₚ is a thermal expansion coefficient of the pipe material, Eₚ is an elastic modulus (Mpa) of the pipe material, ϕ is the Poisson's ratio of the pipe material, r is a radial position (m), and T(r) is the pipe wall temperature (k) at the radial position r.

$$\begin{matrix}Circumferential pressure \text{stress:} & \\ {σ}_{t}^{P} = \frac{{P}_{i n} {R}_{i n}^{2}}{{R}_{ot}^{2} - {R}_{in}^{2}} ( 1 + \frac{{R}_{o t}^{2}}{{r}^{2}} ) & ( 18 ) \\ Radial pressure \text{stress:} & \\ {σ}_{r}^{P} = \frac{{P}_{i n} {R}_{in}^{2}}{{R}_{o t}^{2} - {R}_{in}^{2}} ( 1 - \frac{{R}_{ot}^{2}}{{r}^{2}} ) & ( 19 ) \\ Axial pressure \text{stress:} & \\ {σ}_{1}^{P} = \frac{{P}_{i n} {R}_{i n}^{2}}{{R}_{o t}^{2} - {R}_{i n}^{2}} & ( 20 ) \\ Total circumferential \text{stress:} & \\ {σ}_{t} = {σ}_{t}^{T} + {σ}_{t}^{P} & ( 21 ) \\ Total radial \text{stress:} & \\ {σ}_{r} = {σ}_{r}^{T} + {σ}_{r}^{P} & ( 22 ) \\ Total axial \text{stress:} & \\ {σ}_{1} = {σ}_{1}^{T} + {σ}_{1}^{P} & ( 23 )\end{matrix}$$

wherein Pᵢₙ is an operating pressure (Mpa) of the target pipeline.

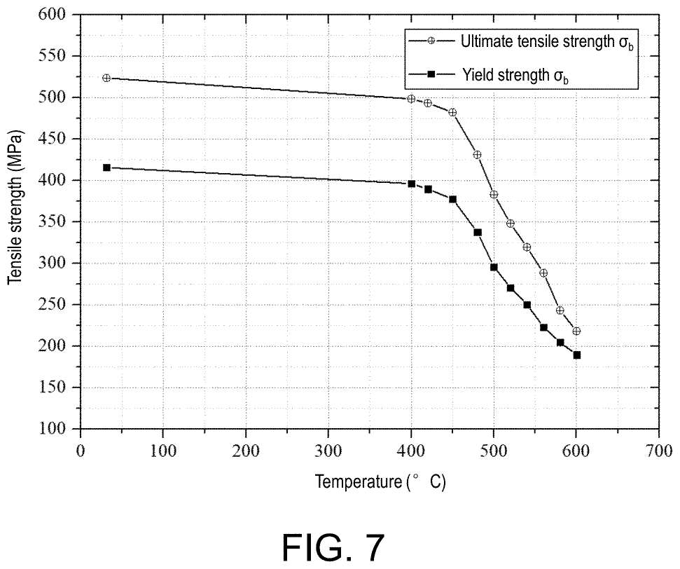

Step (6), carrying out tensile testing at elevated temperature according to testing requirements of Metallic materials—Tensile testing at elevated temperature of the Chinese standard GB/T 4338-2006 to obtain yield strength and ultimate tensile strength of the pipe material API 5L X60 of the target pipeline corresponding to 10 temperature points in the range of 400-600° C., as shown in FIG. 7. The tensile property of the pipe wall material at 400° C. or above starts to be obviously reduced, and the yield strength and the ultimate tensile strength of the pipe wall material at 600° C. are respectively reduced to 45.6% and 41.6% of those of the pipe wall material at normal temperature.

Step (7), according to the total instantaneous circumferential stress result of the pipe wall obtained in the step (5) and the instantaneous tensile strength result of the pipe material obtained through the linear difference value in the step (6), calculating distribution results of the instantaneous fracture failure stress Δσₜ and instantaneous elastic failure stress Δσₑ of the target pipeline by adopting a failure judgment criterion based on the maximum tensile stress theory, wherein the failure result comprises failure time, a failure position, and a failure mode; and the failure judgment expression is as follows:

Elastic failure: max(Δσₑ)=max(σₜ−σₛ)≥0 MPa (24)

Fracture failure: max(Δσᵣ)=max(σₜ−σ_{b})≥0 MPa (25)

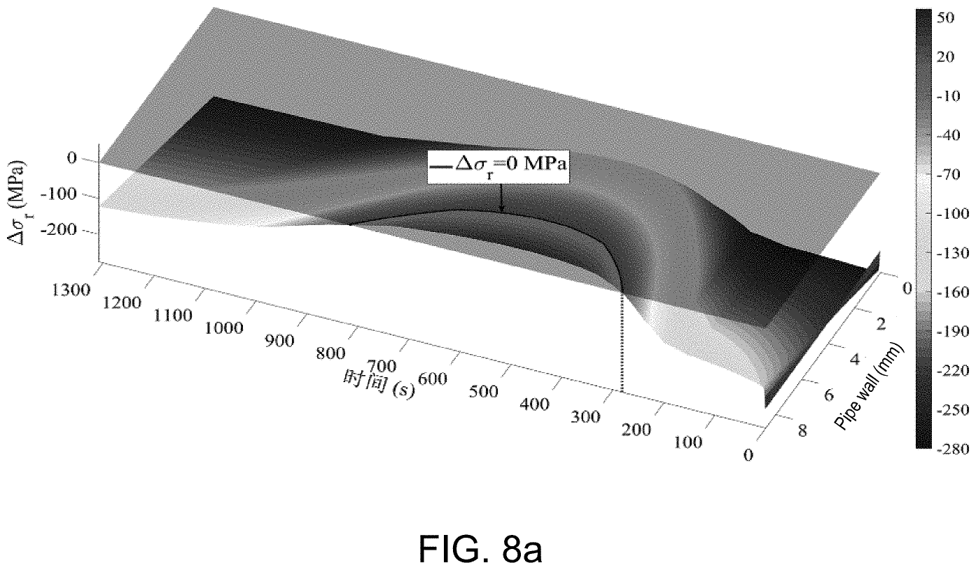

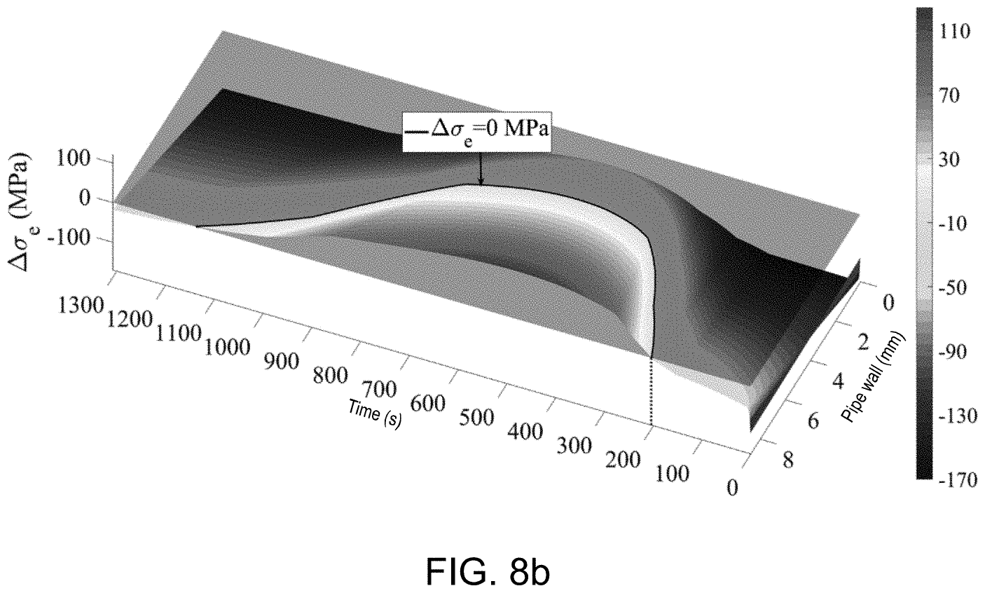

As shown in FIG. 8a and FIG. 8b, the outer wall of the pipeline firstly starts to undergo elastic failure at about the 205-th second, the area of the pipe wall subjected to plastic deformation is gradually increased as the borne total stress continues to increase, and the elastic failure stress reaches the maximum value of 121.0 MPa at about the 481-st second; the outer wall of the pipe wall starts to undergo fracture failure at about the 282-nd second, the area of the pipe wall subjected to fracture failure is gradually increased as the fracture failure stress increases further, and the fracture failure stress also reaches the maximum value of 51.9 MPa at about the 481-st second. It can thus be seen that the target pipeline failure process is as follows: the outer wall of the pipeline and the nearby area start to undergo circumferential plastic deformation due to the fact that the borne total circumferential stress exceeds the yield strength of the pipe material at the corresponding temperature; as the total borne circumferential stress continues to increase to reach the ultimate tensile strength of the pipe material at the corresponding temperature, the outer wall of the pipeline and the nearby area start to undergo fracture failure, local expansion occurs, an axial (perpendicular to main circumferential stress) cracking opening is generated, and local stress concentration is formed at the tip end of the cracking opening, and as the axial cracking opening continues to increase and expand, the complete axial fracture of the pipeline is ultimately caused, which is well matched with a failure mode that two axial ends of the target pipeline are completely fractured in an actual accident scenario, and proves the reliability of the target pipeline dynamic thermal failure analysis method in the present invention.

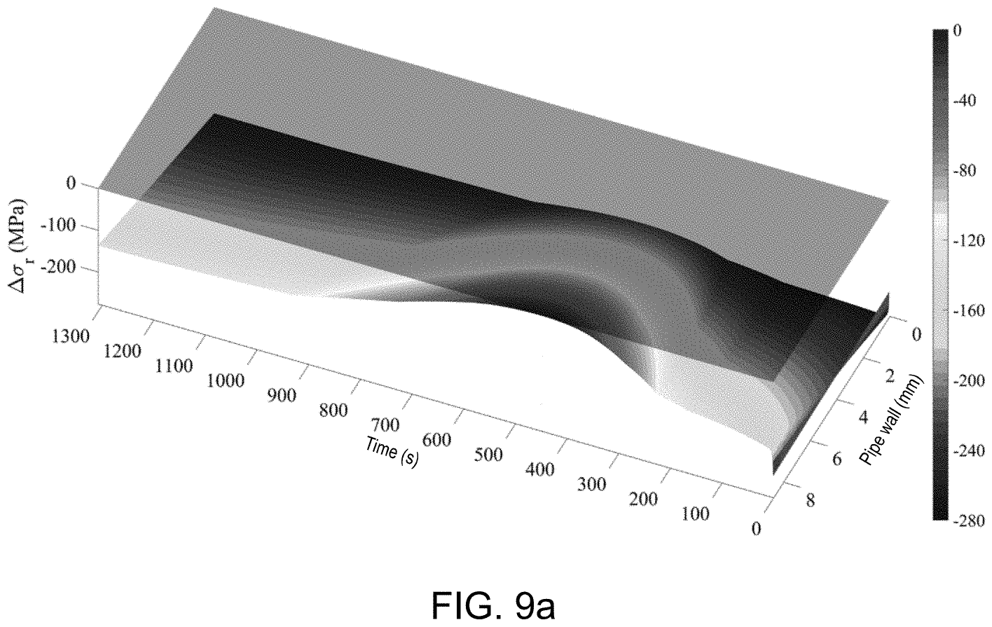

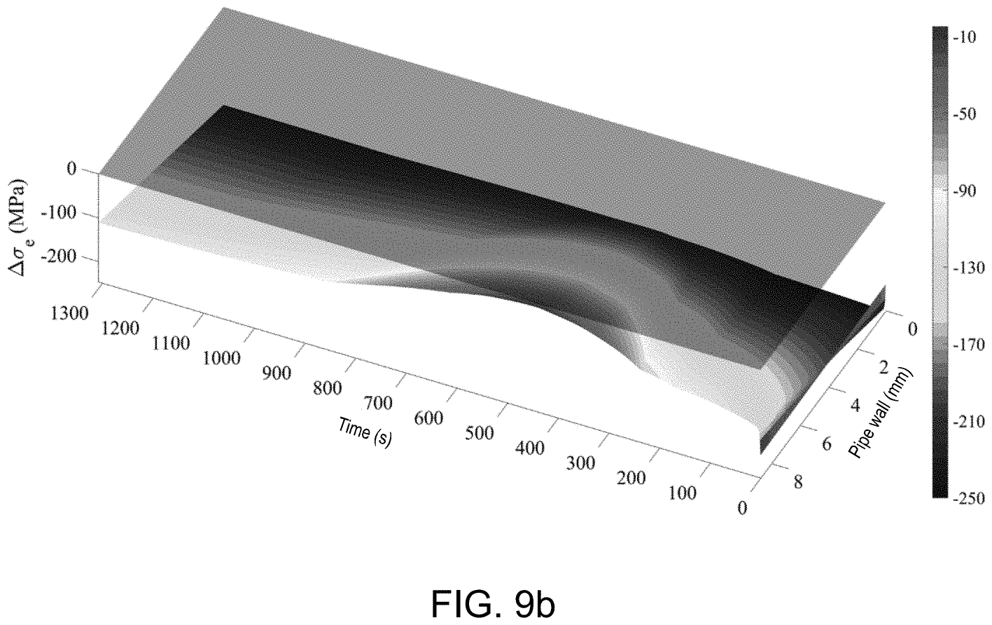

Due to the fact that the target pipeline in this case undergoes thermal failure, the safety spacing of the parallel pipelines needs to be further optimized. As shown in FIG. 9a and FIG. 9b, after the safety spacing is optimized, an analysis calculation result shows that when the safety spacing between the source pipeline and the target pipeline is increased by 11.3%, the maximum fracture failure stress is reduced below 0 MPa, thus the fracture failure of the target pipeline is prevented. When the safety spacing between the source pipeline and the target pipeline is increased by 31.2%, the maximum fracture failure stress is reduced below 0 MPa, thus the elastic failure of the target pipeline is prevented, that is, the target pipeline is in a safety state.

Above embodiments are preferred embodiments of the present invention, but the embodiments of the present invention are not limited by the embodiments described above, and any other changes, modifications, replacements, combinations and simplifications made without departing from the spirit and principles of the present invention should be equivalent substitution modes and are included within the scope of protection of the present invention.

What is claimed is:

1. A target pipeline dynamic thermal failure analysis method in a parallel pipeline jet fire scenario, comprising the following steps:
(1), inputting operation parameters of a source pipeline to obtain an instantaneous thermal radiation value received by a target pipeline in an instantaneous jet fire near field;
(2), establishing a fitting function relational expression of the instantaneous thermal radiation value and time change;
(3), obtaining a convective heat transfer coefficient of an inner wall of the target pipeline;
(4), obtaining an instantaneous temperature distribution result of a pipe wall of the target pipeline;
(5), obtaining instantaneous thermal stress and total instantaneous stress borne by the pipe wall of the target pipeline in a circumferential direction, a radial direction and an axial direction;
(6), carrying out testing to obtain yield strength and ultimate tensile strength corresponding to different temperatures; and
(7), analyzing and judging a target pipeline dynamic failure result, and optimizing a safety spacing of the parallel pipelines for a condition of thermal failure of the target pipeline, thus preventing the target pipeline from thermal failure.

2. The target pipeline dynamic thermal failure analysis method in the parallel pipeline jet fire scenario according to claim 1, wherein the step (1) is specifically as follows:
obtaining the instantaneous thermal radiation value qₜ received by the target pipeline in the instantaneous jet fire near field by using a weighted multi-point source thermal radiation model after heat source weight optimization and improvement, with expressions as follows:
$$\begin{matrix}{q}_{t} = {\sum }_{j = 1}^{N} \frac{{w}_{j} {τ}_{j} {χ}_{r} \dot{m} Δ {H}_{c}}{4 {S}_{j}^{2}} cos {φ}_{j} & ( 1 ) \\ {χ}_{r} = \frac{0.009 \sqrt{{ρ}_{0} / {ρ}_{∞}}}{{f}_{s}} F {r}_{f}^{- 0.265} & ( 2 ) \\ {w}_{j} = \frac{1}{2 a} {e}^{- \frac{\vert {Z}_{j} / {H}_{f} - b \vert}{c}} & ( 3 ) \\ \{ \begin{matrix}a = 0.175 F {r}_{f} + 4.098 \\ b = - 0.0383 F {r}_{f} + 0.67 \\ c = 0.02 F {r}_{f} + 0.247\end{matrix} & ( 4 )\end{matrix}$$
wherein χᵣ is a thermal radiation fraction, wⱼ refers to the heat source weight of the j-th heat source point, Fr_{f} is a flame Froude number, Sⱼ is the distance between a heat source point and an outer wall of the target pipeline, ΔH_{c} is heat of combustion for natural gas, \dot{m} is a mass flow rate of an instantaneous leakage process, τⱼ is an air transmissivity, H_{f} is a visible flame length, N is the total number of flame axial heat source points, Zⱼ is an axial position of the j-th heat source point, φⱼ is an included angle between a connecting line of the j-th heat source point and a target and a normal direction of a target surface, ρ₀ is the density of natural gas, ρ_{∞} is the density of ambient air, and a, b and c are constant coefficients.

3. The target pipeline dynamic thermal failure analysis method in the parallel pipeline jet fire scenario according to claim 1, wherein in the step (2), a Levebberg-Marquardt algorithm is used to perform fitting to obtain the fitting function relational expression of the instantaneous thermal radiation value and the time change.

4. The target pipeline dynamic thermal failure analysis method in the parallel pipeline jet fire scenario according to claim 1, wherein an obtaining mode of the step (3) is as follows:
$$\begin{matrix}{h}_{in} = N {u}_{in} \frac{k}{{D}_{in}} & ( 5 ) \\ N {u}_{in} = \frac{( R {e}_{in} - 1000 ) P r ( {f}_{F} / 8 )}{1 + 12.7 {( {f}_{F} / 8 )}^{0.5} [ P {r}^{2 / 3} - 1 ]} & ( 6 ) \\ {f}_{F} = \frac{1}{{4 [ 1.14 - 2 {log}_{10} ( ɛ / {D}_{in} ) ]}^{2}} , \frac{ɛ}{{D}_{in}} \frac{9.35}{R {e}_{i n} \sqrt{4 {f}_{F}}} & ( 7 )\end{matrix}$$
wherein hᵢₙ is a convective heat transfer coefficient of an inner wall of the target pipeline, Dᵢₙ is an inner diameter of the target pipeline, Nuᵢₙ is a heat transfer Nusselt number of the inner wall of the pipeline, f_{F} is a Fanning friction factor of the inner wall of the pipeline, k is a heat conductivity of a pipe material, Reᵢₙ is a Reynolds number of the natural gas in the pipe; Pr is a Prandtl number of the natural gas, and ε is the roughness of the inner wall of the pipeline.

5. The target pipeline dynamic thermal failure analysis method in the parallel pipeline jet fire scenario according to claim 1, wherein in the step (4), by taking the function relational expression obtained in the step (2) as an outer wall heat source input boundary condition and taking convective heat transfer coefficient of the inner wall of the target pipeline obtained in the step (3) as an inner wall forced-convection heat transfer boundary condition, a dynamic thermal response finite difference model of the target pipeline under the action of instantaneous thermal radiation is established based on a MATLAB software platform, thus obtaining an instantaneous temperature T_{m,n}⁽ⁱ⁾ distribution result of the pipe wall; corresponding expressions of the inner wall boundary condition and the outer wall boundary condition in the finite difference model are as follows:
the expression of the outer wall heat source input boundary condition is as follows:
$$k Δ y \frac{{T}_{m - 1 , n}^{( i )} - {T}_{m , n}^{( i )}}{Δ x} + k \frac{{T}_{m , n + 1}^{( i )} - {T}_{m , n}^{( i )}}{Δ y} \frac{Δ x}{2} + k \frac{Δ x}{2} \frac{{T}_{m , n - 1}^{( i )} - {T}_{m , n}^{( i )}}{Δ y} + {q}_{t}^{( i )} Δ y = ρ C \frac{{T}_{m , n}^{( i + 1 )} - {T}_{m , n}^{( i )}}{Δ t} \frac{Δ x}{2} Δ y \qquad ( 8 )$$
the expression of the inner wall forced-convection heat transfer boundary condition is as follows:
$$k Δ y \frac{{T}_{m - 1 , n}^{( i )} - {T}_{m , n}^{( i )}}{Δ x} + k \frac{{T}_{m , n + 1}^{( i )} - {T}_{m , n}^{( i )}}{Δ y} \frac{Δ x}{2} + k \frac{Δ x}{2} \frac{{T}_{m , n - 1}^{( i )} - {T}_{m , n}^{( i )}}{Δ y} + {h}_{m} ( {T}_{in} - {T}_{m , n}^{( i )} ) Δ y = ρ C \frac{{T}_{m , n}^{( i + 1 )} - {T}_{m , n}^{( i )}}{Δ t} \frac{Δ x}{2} Δ y \qquad ( 9 )$$
wherein k is the heat conductivity of the pipe material, Δy and Δx are respectively a radial distance step and an axial distance step of the pipe wall, qₜ⁽ⁱ⁾ is the instantaneous thermal flux received by the outer wall of the pipeline at the moment i, ρ is the density of the pipe material, C is the specific heat capacity of the pipe material, Δt is a time step, Tᵢₙ is a temperature of the natural gas in the pipe, n and m are the number of axial nodes and the number of radial nodes, and i is time.

6. The target pipeline dynamic thermal failure analysis method in the parallel pipeline jet fire scenario according to claim 1, wherein in the step (5), the instantaneous thermal stress σ^{T} borne by the pipe wall in a circumferential direction, a radial direction and an axial direction is obtained based on the instantaneous temperature distribution result of the pipe wall obtained in the step (4), and a result of a total instantaneous stress σ born by the pipe wall is obtained by superposing pressure stress generated by the internal pressure of the pipeline, the corresponding expressions are as follows:
$$\begin{matrix}circumferential thermal \text{stress:} \\ & \\ {σ}_{t}^{T} = \frac{{τ}_{p} {E}_{p}}{( 1 - ϕ ) {r}^{2}} [ \frac{{r}^{2} + {R}_{i n}^{2}}{{R}_{ot}^{2} - {R}_{i n}^{2}} {\int }_{{R}_{in}}^{{R}_{ot}} T ( r ) r d r + {\int }_{{R}_{in}}^{r} T ( r ) r d r - T ( r ) {r}^{2} ] & ( 10 ) \\ radial thermal \text{stress:} & \\ {σ}_{r}^{T} = \frac{{τ}_{p} {E}_{p}}{( 1 - ϕ ) {r}^{2}} [ \frac{{r}^{2} - {R}_{i n}^{2}}{{R}_{ot}^{2} - {R}_{i n}^{2}} {\int }_{{R}_{in}}^{{R}_{ot}} T ( r ) r d r - {\int }_{{R}_{in}}^{r} T ( r ) r d r ] & ( 11 ) \\ axial thermal \text{stress:} & \\ {σ}_{1}^{T} = \frac{{τ}_{p} {E}_{p}}{1 - ϕ} [ \frac{2}{{R}_{ot}^{2} - {R}_{i n}^{2}} {\int }_{{R}_{in}}^{{R}_{ot}} T ( r ) r d r - T ( r ) ] & ( 12 )\end{matrix}$$
wherein Rₒₜ is an outer radius of the pipe wall, Rᵢₙ is an inner radius of the pipe wall, τₚ is a thermal expansion coefficient of the pipe material, Eₚ is an elastic modulus of the pipe material, φ is the Poisson's ratio of the pipe material, r is a radial position, and T(r) is a pipe wall temperature at the radial position r;
$$\begin{matrix}c ircumferential pressure \text{stress:} & \\ {σ}_{t}^{P} = \frac{{P}_{i n} {R}_{i n}^{2}}{{R}_{ot}^{2} - {R}_{in}^{2}} ( 1 + \frac{{R}_{o t}^{2}}{{r}^{2}} ) & ( 13 ) \\ r adial pressure \text{stress:} & \\ {σ}_{r}^{P} = \frac{{P}_{i n} {R}_{in}^{2}}{{R}_{o t}^{2} - {R}_{in}^{2}} ( 1 - \frac{{R}_{ot}^{2}}{{r}^{2}} ) & ( 14 ) \\ a xial pressure \text{stress:} & \\ {σ}_{1}^{P} = \frac{{P}_{i n} {R}_{i n}^{2}}{{R}_{o t}^{2} - {R}_{i n}^{2}} & ( 15 ) \\ t otal circumferential \text{stress:} & \\ {σ}_{t} = {σ}_{t}^{T} + {σ}_{t}^{P} & ( 16 ) \\ t otal radial \text{stress:} & \\ {σ}_{r} = {σ}_{r}^{T} + {σ}_{r}^{P} & ( 17 ) \\ t otal axial \text{stress:} & \\ {σ}_{1} = {σ}_{1}^{T} + {σ}_{1}^{P} & ( 18 )\end{matrix}$$
wherein Pᵢₙ is an operating pressure of the target pipeline.

7. The target pipeline dynamic thermal failure analysis method in the parallel pipeline jet fire scenario according to claim 1, wherein in the step (6), a tensile strength data result of the pipe material under different temperatures is obtained by a tensile testing at elevated temperature according to the temperature range of the pipe wall obtained in the step (4), and the yield strength σₛ and ultimate tensile strength σ_{b} corresponding to any temperature in the test temperature range are obtained through a linear difference value.

8. The target pipeline dynamic thermal failure analysis method in the parallel pipeline jet fire scenario according to claim 1, wherein in the step (7), by adopting a failure judgment criterion based on the maximum tensile stress theory, the elastic failure stress Δσₑ of the target pipeline is defined as a difference value obtained by subtracting the yield strength of the pipe material at the corresponding temperature from the obtained total stress in each direction born by a certain position of the pipe wall, the judgment criterion of the elastic failure of the pipeline is that the maximum elastic failure stress max(Δσₑ) of the pipe wall is greater than or equal to 0 MPa; and meanwhile, the fracture failure stress Δσᵣ of target pipeline is defined as a difference value obtained by subtracting the ultimate tensile strength of the pipe material at corresponding temperature from obtained total stress in each direction born by a certain position of the pipe wall, and the judgment criterion of the elastic failure of the pipeline is that the maximum fracture failure stress max(Δσₑ) of the pipe wall is greater than or equal to 0 MPa; a failure result of the target pipeline is accurately obtained according to the failure judgment criterion, the failure result comprises failure time, failure position, and failure mode; and the failure judgment expression is as follows:
elastic failure: max(Δσₑ)=max(σₜ−σₛ)≥0 MPa (19)
fracture failure: max(Δσᵣ)=max(σₜ−σ_{b})≥0 MPa (20)
if the analysis result shows that the target pipeline undergoes the thermal failure, the safety spacing between the parallel pipelines is further optimized, and above calculation and analysis are repeated until the analysis result is that the target pipeline is safe.
